(19) United States
(12) Patent Application Publication
(10) Pub. No.: US 2015/0187016 A1
(43) Pub. Date: Jul. 2, 2015

(54) SYSTEM AND METHOD FOR TELEMATICS BASED UNDERWRITING

(71) Applicant: Hartford Fire Insurance Company, Hartford, CT (US)

(72) Inventors: Isaac D. Adams, Canton, CT (US); Steven J. Fernandes, West Hartford, CT (US); Marc J. Natrillo, Avon, CT (US); Paul Brendan Olson, Hartford, CT (US); Pankaj Prakash, Rocky Hill, CT (US)

(73) Assignee: Hartford Fire Insurance Company, Hartford, CT (US)

(21) Appl. No.: 14/145,205

(22) Filed: Dec. 31, 2013

(51) Int. Cl. G06Q 40/08

(52) U.S. Cl. CPC G06Q 40/08

(57) ABSTRACT

A system for determining insurance pricing information comprising a computer memory for storing biographical information, including an expected total mileage driven by a vehicle and an initial risk assessment based on at least the expected total mileage driven; the processor further configured to determine, based on telematics data, a plurality of relativity factors, wherein relativity factors are numerical values generated based on a comparison of the information associated with the received telematics data with other drivers; the processor configured to calculate the product of the plurality of relativity factors with a starting discount and compare the product with a predetermined threshold; the processor further configured to adjust insurance pricing information based on the comparison of the product of the relativity factors with the predetermined threshold.

### INCORPORATION BY REFERENCE

The following documents are incorporated herein by reference as if fully set forth: U.S. application Ser. No. 14/145,142, titled SYSTEM AND METHOD FOR DETERMINING DRIVER SIGNATURES filed Dec. 31, 2013; U.S. application Ser. No. 14/145,165, titled SYSTEM AND METHOD FOR EXPECTATION BASED PROCESSING filed Dec. 31, 2013; and U.S. application Ser. No. 14/145,181, titled SYSTEM AND METHOD FOR DESTINATION BASED UNDERWRITING filed Dec. 31, 2013. Each of the applications shares common inventorship with the present application and are being filed concurrently.

### BACKGROUND

A vehicle insurance policy may include several types of coverage: bodily injury liability, property damage liability, medical payments, uninsured motorist protection, collision coverage and comprehensive (physical damage). Biographical information is often used as a proxy for actual driving information to determine insurance risk scores for a policy. In this way, in lieu of twenty four hour monitoring of driving behavior, insurance companies have correlated biographical indicators with the chances of a claim (expected losses) being filed.

While these biographical indicators may statistically provide accurate information to an insurance company from a business sense, it may not provide the granularity to accurately assess the risk of a particular driver.

Accordingly, methods and apparatus using telematics are described for telematics based underwriting.

### SUMMARY

A system is disclosed for determining risk associated with a driver. The disclosed system comprising a computer memory for receiving biographical information associated with one or more drivers, the biographical information including an expected total mileage driven by a vehicle; the memory further configured to store loss data; a processor configured to generate an initial risk assessment based on at least the expected total mileage driven; the processor further configured to generate an insurance quote based at least in part on the initial risk assessment; a receiver, configured to receive from a telematics device, telematics data indicating at least vehicle location and speed and a time stamp; the processor further configured to determine, based at least in part on the telematics data, a plurality of relativity factors; the processor configured to calculate the product of the plurality relativity factors with a starting discount and compare the product with a predetermined threshold; and the processor further configured to adjust pricing information based on the comparison of the product of the relativity factors with the predetermined threshold.

### BRIEF DESCRIPTION OF THE DRAWINGS

A more detailed understanding may be had from the following description, given by way of example in conjunction with the accompanying drawings wherein:

FIG. 1 shows an example system architecture that may be used for telematics based underwriting;

FIG. 2 shows a flow diagram for a method for telematics based underwriting;

FIG. 3 is an example web page for initiating a request for a vehicle insurance quote;

FIG. 4 is an example web page soliciting preliminary information regarding a request for a vehicle insurance quote;

FIG. 5 is an example web page soliciting additional preliminary information regarding a request for a vehicle insurance quote;

FIG. 6 is an example web page soliciting name and address information of the individual requesting a vehicle insurance quote;

FIG. 7 is an example web page soliciting vehicle information regarding a request for a vehicle insurance quote;

FIG. 8 is an example web page soliciting additional vehicle information regarding a request for a vehicle insurance quote;

FIG. 9 is an example web page soliciting driver information regarding a request for a vehicle insurance quote;

FIG. 10 is an example web page soliciting additional driver information regarding a request for a vehicle insurance quote;

FIG. 11 is another example web page soliciting additional driver information regarding a request for a vehicle insurance quote;

FIG. 12 is an example web page soliciting driver history information regarding a request for a vehicle insurance quote;

FIG. 13 is an example web page soliciting a response from the user for registration to TrueLane® telematics program;

FIG. 14 shows an example diagram of an embodiment of a system for telematics based underwriting.

FIG. 15 shows an example electronic device that may be used to implement features described herein with reference to FIGS. 1-14;

FIG. 16 shows an example graph for a DLRI for a location based calculation, wherein the location size is based on the zip code;

FIG. 17 shows an example graph for defining road segments that may be used for a road segment based calculation; and

FIGS. 18A and 18B show example graphs showing high braking relativity per road segment and low braking relativity per road segment.

### DETAILED DESCRIPTION

Disclosed herein are processor-executable methods, computing systems, and related technologies for telematics based underwriting.

In one example, the processor-executable methods and computing systems are configured to use relativity information in the underwriting process. The system may determine expected losses based on loss experience and actual driving behavior.

During a registration phase for vehicle insurance, an account template is opened for a potential customer. The insurance company or an insurance agent may request biographical data, for example via a webpage, to populate information in the account template. The biographical data, may include: name, age, gender, occupation, vehicle, driving history, geographical location, grades (if the driver is a student), and frequency of use of the vehicle. Once the account template is completed, the biographical data stored in the account template is formatted and stored in a database. The system, using software based statistical analysis (e.g. regression analysis) compares the biographical data with actuarial data stored in the system. This actuarial data may include demographic data related to insurance pricing and may include loss data. The system, using the results of the statistical analysis generates an initial risk assessment for the account. As an example, the risk assessment may be categorized by vehicle or by driver. This risk assessment may ultimately be used to determine whether to offer coverage, the rate associated with the coverage, and discount or penalize the rate associated with the coverage.

As will be greater described in detail below, telematics data is collected from the vehicle, providing the insurance company with information such as speed, acceleration, deceleration, left turns, right turns, braking, time of day, mileage, and location.

The telematics data may be analyzed based on stored demographic information, to determine a plurality of relativity factors. These relativity factors may be based on speeding, braking, acceleration, turns, mileage, time of day analysis, driving location risk, distracted driving, hot spot driving, and the types of weather during driving. Further these relativity factors may be numeric value(s) for a type of measured driving behavior. The relativity factor may be relative to other drivers within the same demographic, driving on the same or similar roads under the same or similar conditions, or to the posted speed limit, or driving regulations. Based on the determined relativity factors, the system can determine a discount relativity factor. A computer system then uses a multivariate analysis to generate an adjusted risk score based on the results of this analysis. This risk score may be used to determine adjusted rates. The adjusted rates may be for an overall policy adjustment or for specific coverage, such as for property damage liability, medical payments, uninsured motorist protection, collision coverage, and comprehensive physical damage more accurately.

The telematics data may be received for a predetermined time period. In one example, a telematics device may be installed in a vehicle for a six month period over which data is collected. Because of seasonal changes in driving patterns, (e.g. for students no school during summer time), the DCU 110 may be configured to account for these differences and compensate for seasonal variations by weighting the time frame of the use, using a seasonality factor. Alternatively, the telematics device may be installed for a full year, or be permanently installed. In another embodiment, a software application installed on a mobile phone or other wireless device may be configured to generate the telematics data and communicate with the system 100.

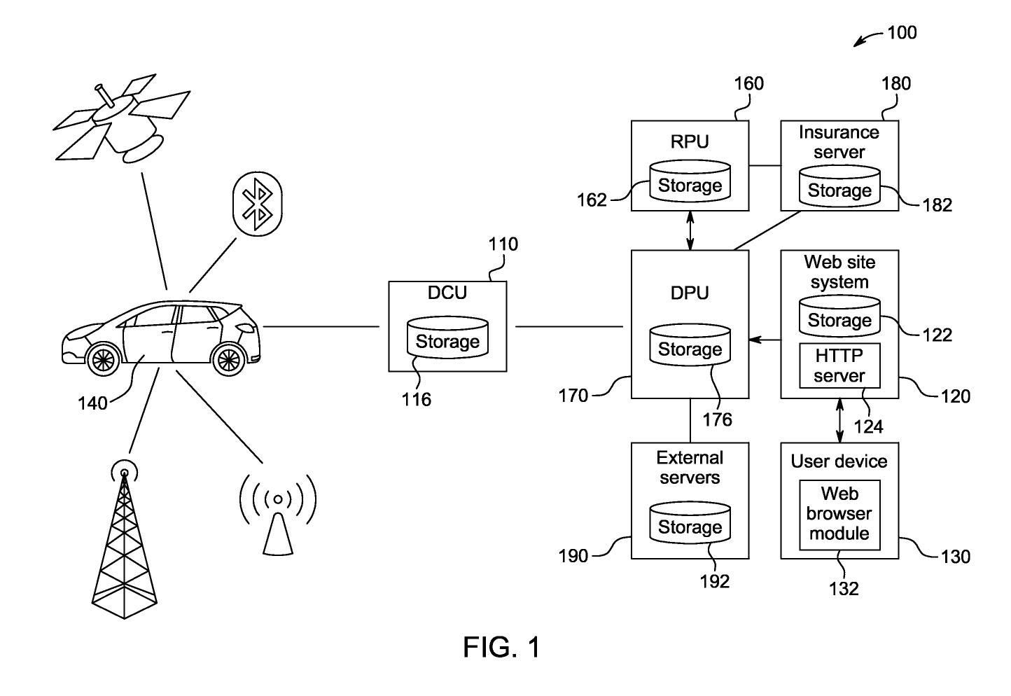

FIG. 1 shows an example system 100 that may be used for telematics based underwriting. The example system 100 includes a vehicle 140 equipped with one or more telematics devices (not pictured), for example a TrueLane® device. The telematics devices may further include smartphones, tablets and/or similar devices. The vehicle 140 may be in communication with multiple devices over different networks, including a satellite, a cellular station, a Wi-Fi hotspot, BLUETOOTH devices, and a data collection unit (DCU) 110. The DCU 110 may include storage 116. The DCU 110 may be operated by a third party vendor that collects telematics data. The DCU 110 collects the telematics data and then may transmit the telematics data to a data processing unit (DPU) 170. The telematics data may be communicated to the DPU 170 in any number of formats. In one embodiment, the DCU 110 may transmit a customized summary form of the telematics data to the DPU 170, in a format useable by the DPU 170. The DPU 170 may also be configured to communicate with a risk and pricing unit (RPU) 160, including storage 162, internal insurance servers 180, including storage 182, and external servers 190 (e.g. social media networks, official/government networks), which are all connected by one or more networks.

The one or more telematics devices associated with the vehicle 140 may communicate with a satellite, Wi-Fi hotspot and even other vehicles. The telematics devices associated with the vehicle 140 report this information to the DCU 110. As will be described in greater detail hereafter, the DCU 110 may transmit this telematics data to the DPU 170 which may be configured to use telematics data to generate relativity factors.

The web site system 120 provides a web site that may be accessed by a user device 130. The web site system 120 includes a Hypertext Transfer Protocol (HTTP) server module 124 and a database 122. The HTTP server module 124 may implement the HTTP protocol, and may communicate Hypertext Markup Language (HTML) pages and related data from the web site to/from the user device 130 using HTTP. The web site system 120 may be connected to one or more private or public networks (such as the Internet), via which the web site system 120 communicates with devices such as the user device 130. The web site system 120 may generate one or more web pages that may communicate the web pages to the user device 130, and may receive responsive information from the user device 130.

The HTTP server module 124 in the web site system 120 may be, for example, an APACHE HTTP server, a SUN-ONE Web Server, a MICROSOFT Internet Information Services (IIS) server, and/or may be based on any other appropriate HTTP server technology. The web site system 120 may also include one or more additional components or modules (not depicted), such as one or more load balancers, firewall devices, routers, switches, and devices that handle power backup and data redundancy.

The user device 130 may be, for example, a cellular phone, a desktop computer, a laptop computer, a tablet computer, or any other appropriate computing device. The user device 130 includes a web browser module 132, which may communicate data related to the web site to/from the HTTP server module 124 in the web site system 120. The web browser module 132 may include and/or communicate with one or more sub-modules that perform functionality such as rendering HTML (including but not limited to HTML5), rendering raster and/or vector graphics, executing JavaScript, and/or rendering multimedia content. Alternatively or additionally, the web browser module 132 may implement Rich Internet Application (RIA) and/or multimedia technologies such as ADOBE FLASH, MICROSOFT SILVERLIGHT, and/or other technologies. The web browser module 132 may implement RIA and/or multimedia technologies using one or web browser plug-in modules (such as, for example, an ADOBE FLASH or MICROSOFT SILVERLIGHT plug-in), and/or using one or more sub-modules within the web browser module 132 itself. The web browser module 132 may display data on one or more display devices (not depicted) that are included in or connected to the user device 130, such as a liquid crystal display (LCD) display or monitor. The user device 130 may receive input from the user of the user device 130 from input devices (not depicted) that are included in or connected to the user device 130, such as a keyboard, a mouse, or a touch screen, and provide data that indicates the input to the web browser module 132.

The example architecture of system 100 of FIG. 1 may also include one or more wired and/or wireless networks (not depicted), via which communications between the elements in the example architecture of system 100 may take place. The networks may be private or public networks, and/or may include the Internet.

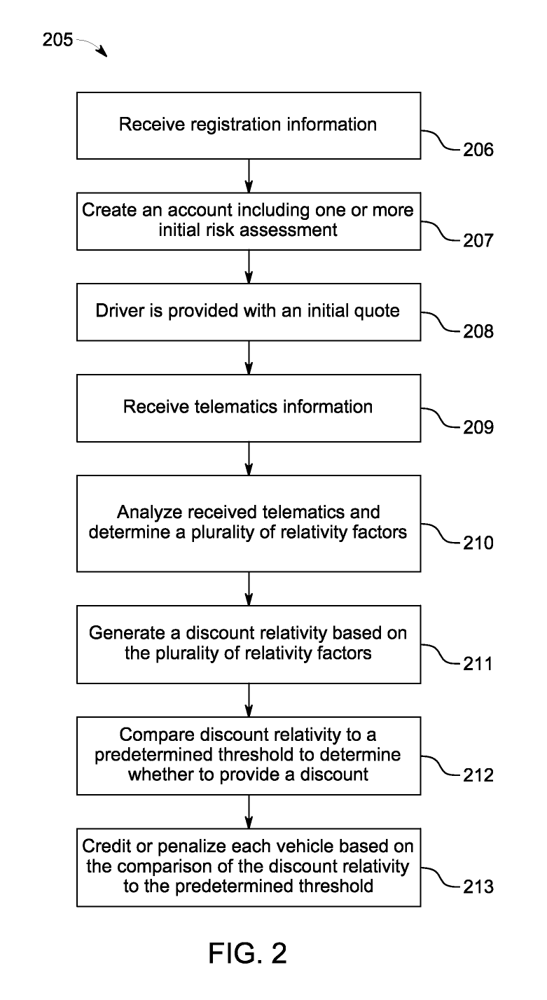

Each or any combination of the modules shown in FIG. 1 may be implemented as one or more software modules, one or more specific-purpose processor elements, or as combinations thereof. Suitable software modules include, by way of example, an executable program, a function, a method call, a procedure, a routine or sub-routine, one or more processor-executable instructions, an object, or a data structure. In addition or as an alternative to the features of these modules described above with reference to FIG. 1, these modules may perform functionality described herein with reference to FIGS. 2-18.

FIG. 2 shows an example use case for method 205 for telematics based underwriting. The system 100 receives registration information regarding the user (step 206). This information may include biographical information (such as the numbers of family members, age, marital status, education, address information, number and type of vehicles). In one embodiment, this information may be received via a website. Based on this information, the system 100 creates a group account (step 207). The group account may include subaccounts for each individual driver (in the case of multiple insured). The system 100 uses a software based algorithm to generate initial risk assessments, based on stored demographic data and loss data. For example, if there are two drivers and two vehicles, and each vehicle is driven by only one driver, the system 100 generates a vehicle risk assessment which incorporates the likelihood of a claim being made related to the vehicle and the expected severity of such a claim. The initial risk assessment may be based on the expected locations in which the vehicle is to be stored and the expected risk behavior of the operator of the vehicle. The system 100 may then generate pricing information based on this initial risk assessment (step 208). For example, the pricing information may include quote/premium information. If the user accepts the premium, the account is activated and the system 100 begins receiving and stores telematics data associated with the account (step 209). At predetermined intervals or based on triggering events, the telematics device may push telematics data to the system 100 or the system 100 may pull telematics data from the device and store the information in a database. The system 100 receives the telematics data, and determines a plurality of relativity factors (step 210). The system 100 may then use the determined relativity factors to determine a discount relativity (step 211). The system 100 may compare the determined discount relativity to a predetermined threshold to determine whether to provide a discount (step 212). Using software based algorithms, the system 100 may credit or penalize each vehicle based on the comparison of the discount relativity to the predetermined threshold and determine an adjusted rate, an adjusted risk score, provide a credit or surcharge, deny coverage, or recommend a different insurance product (step 213).

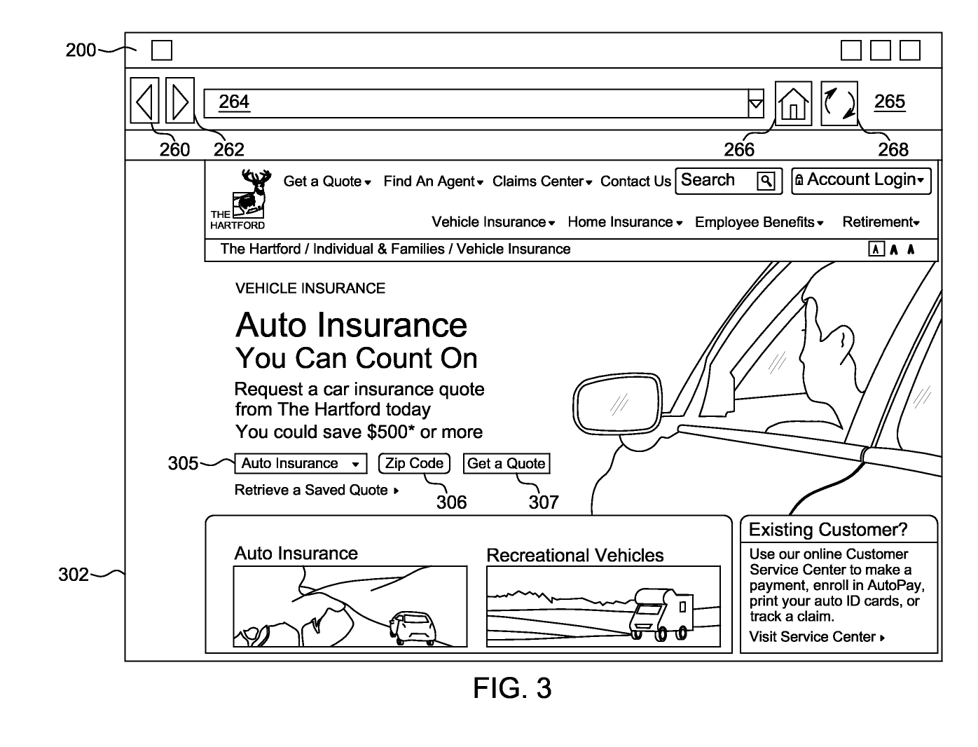

FIGS. 3-13 show example web pages that may be displayed by the web browser module 132. As will be described in detail below, the web pages may include display elements which allow the user of the user device 130 to interface with the system 100 and register or receive a quote for vehicle insurance. The web pages may be included in a web browser window 200 that is displayed and managed by the web browser module 132. The web pages may include data received by the web browser module 132 from the web site system 120. The web pages may include vehicle insurance information.

The web browser window 200 may include a control area 265 that includes a back button 260, forward button 262, address field 264, home button 266, and refresh button 268. The control area 265 may also include one or more additional control elements (not depicted). The user of the user device 130 may select the control elements 260, 262, 264, 266, 268 in the control area 265. The selection may be performed, for example, by the user clicking a mouse or providing input via keyboard, touch screen, and/or other type of input device. When one of the control elements 260, 262, 264, 266, 268 is selected, the web browser module 132 may perform an action that corresponds to the selected element. For example, when the refresh button 268 is selected, the web browser module 132 may refresh the page currently viewed in the web browser window 200.

FIG. 3 is an example web page 302 for initiating a request for a vehicle insurance quote. As shown in FIG. 3, the web page 302 may include questions accompanied by multiple input fields 305-307 in the form of drop down lists, text fields, and radio buttons. As the user provides input into the input fields 305-307, the web browser module 132 may store one or more data structures (“response data”) that reflect the selections made in the input fields 305-307. Further, as the selections are updated, the web browser module 132 may update the web page 302 to indicate additional or more specific questions that may be associated with the selections. If there are no errors in the transmission, the web browser module 132 is directed to a subsequent web page. While the example shown is for auto insurance, the methods and apparatus disclosed herein may be applied to any vehicle insurance, e.g. boats, planes, motorcycles etc. Also, while the examples are directed to family auto insurance, the methods and apparatus disclosed herein may be applicable to corporate insurance plans, or any policies covering vehicles.

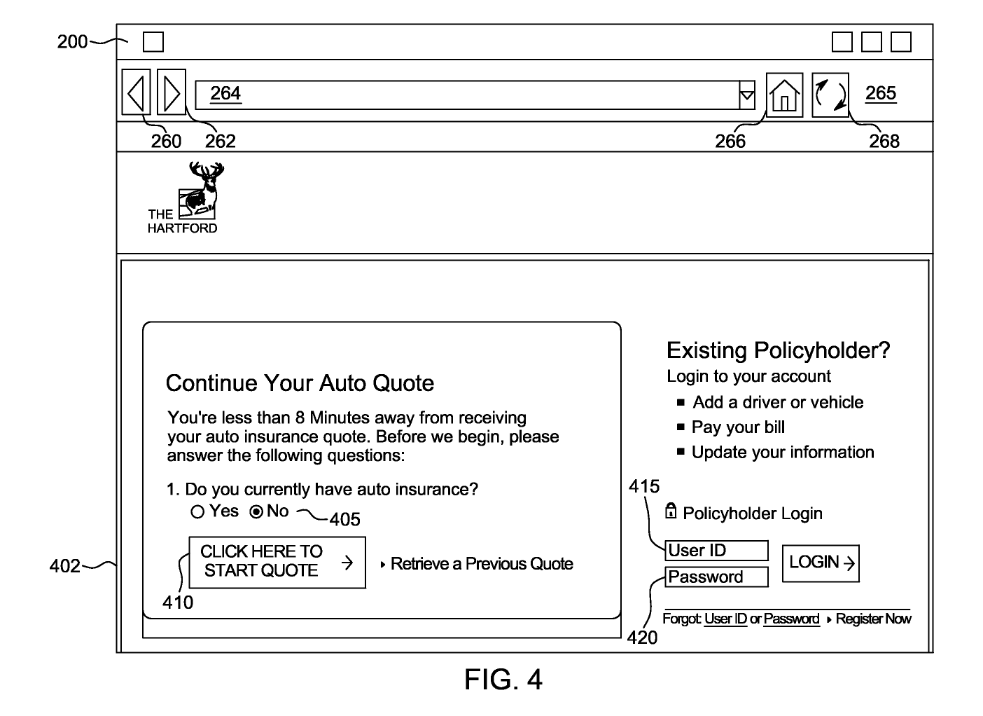

FIG. 4 is an example web page 402 soliciting preliminary information regarding a request for a vehicle insurance quote. As shown in FIG. 4, the web page 402 may include multiple input fields 405, 410, 415, and 420. As the user device 130 receives input for the input fields, the web browser module 132 may store one or more data structures (“response data”) that reflect the selections made in the input fields. Further, as the selections are updated, the web browser module 132 may update the web page 402 to indicate additional or more specific questions that may be associated with the selections. At any time, while viewing the web page 402 of FIG. 4, the user may enter user identification information in input fields 415 and 420, which accesses previously stored information associated with the user. If there are no errors in the transmission, the web browser module 132 is directed to a subsequent web page.

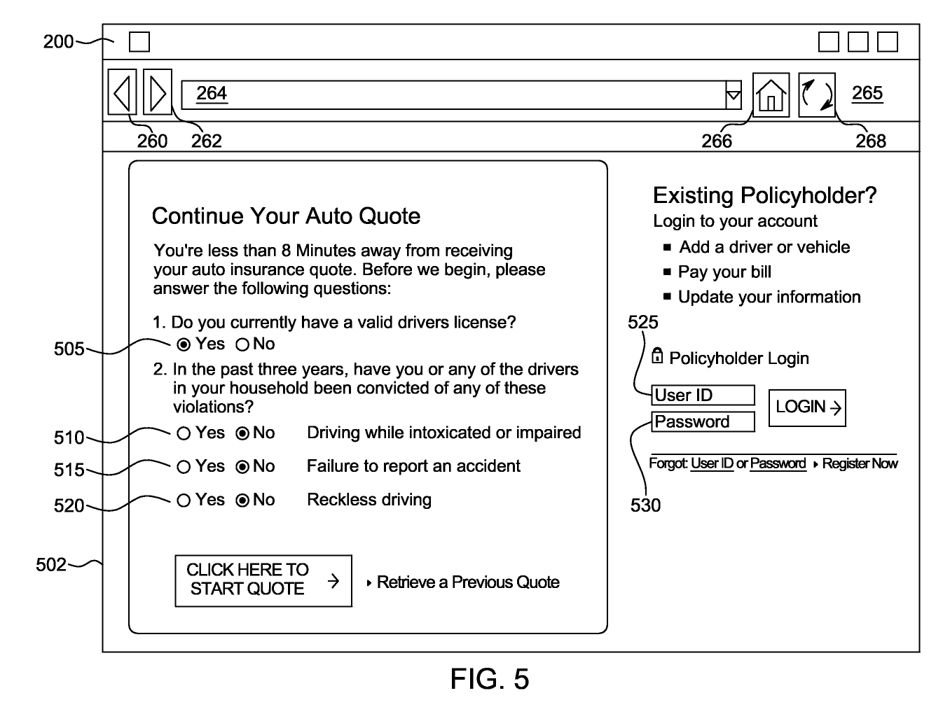

FIG. 5 is an example web page 502 soliciting additional preliminary information regarding a request for a vehicle insurance quote. As shown in FIG. 5, the web page 502 may include multiple input fields 505, 510, 515, 520, 525, and 530. As the user device 130 receives input for the input fields, the web browser module 132 may store one or more data structures (“response data”) that reflect the selections made in the input fields. Further, as the selections are updated, the web browser module 132 may update the web page 502 to indicate additional or more specific questions that may be associated with the selections. At any time, while viewing the web page 502 of FIG. 5, the user may enter user identification information in input fields 525 and 530, which accesses previously stored information associated with the user. Web page 502 solicits additional questions, for example, whether the user currently has a valid driver's license and whether the user or associated family has had any major driving violations. Such violations alert the system 100 that the user may be directed to a different insurance product. Additionally, while the telematics program is voluntary for some users, in one embodiment, a potential user may be eligible for additional products if they consent to using the telematics program, whereas previously they may have been disqualified. If there are no errors in the transmission, the web browser module 132 is directed to a subsequent web page.

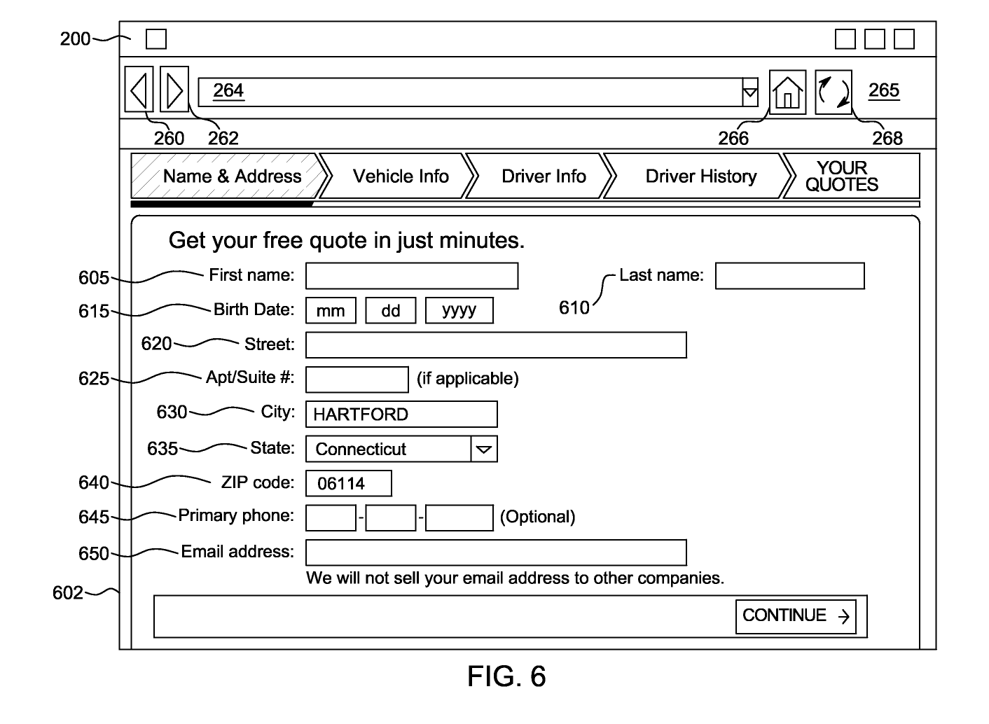

FIG. 6 is an example web page 602 soliciting name and address information of the individual requesting an insurance quote. As shown in FIG. 6, the web page 602 may include multiple input fields 605, 610, 615, 620, 625, 630, 635, 640, 645 and 650. As the user device 130 receives input for the input fields, the web browser module 132 may store one or more data structures (“response data”) that reflect the selections made in the input fields. Further, as the selections are updated, the web browser module 132 may update the web page 602 to indicate additional or more specific questions that may be associated with the selections. The questions displayed on web page 602 solicit questions regarding the contact information of the individual applying for insurance. As an example, the questions shown in FIG. 6 include: name, date of birth, address, phone number, and email address. If there are no errors in the transmission, the web browser module 132 is directed to a subsequent web page.

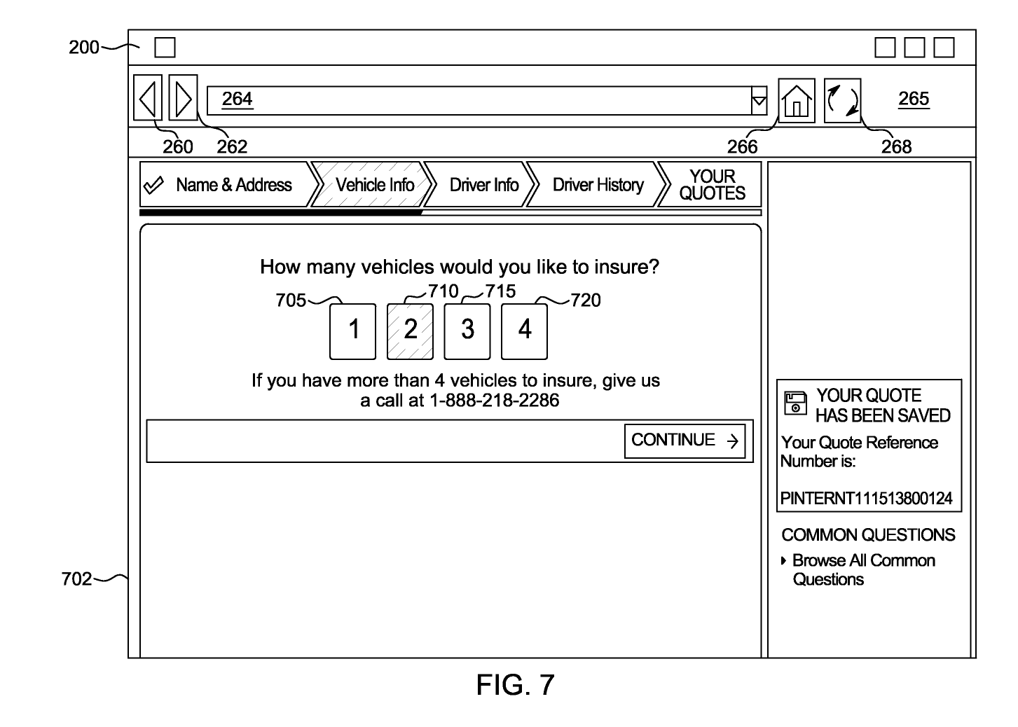

FIG. 7 is an example web page 702 soliciting vehicle information regarding a request for a vehicle insurance quote. As shown in FIG. 7, the web page 702 may include radio buttons 705, 710, 715, and 720. As the user device 130 receives input selecting a radio button, the web browser module 132 may store one or more data structures (“response data”) that reflect the selections made. Further, as the selections are updated, the web browser module 132 may update the web page 702 to indicate additional or more specific questions that may be associated with the selections. The question displayed on web page 702 solicits information regarding the number of vehicles for which insurance is being requested. While the example shown in FIG. 7 only allows four vehicles, this is as an example only. More or less vehicles may be allowed. If there are no errors in the transmission, the web browser module 132 is directed to a subsequent web page.

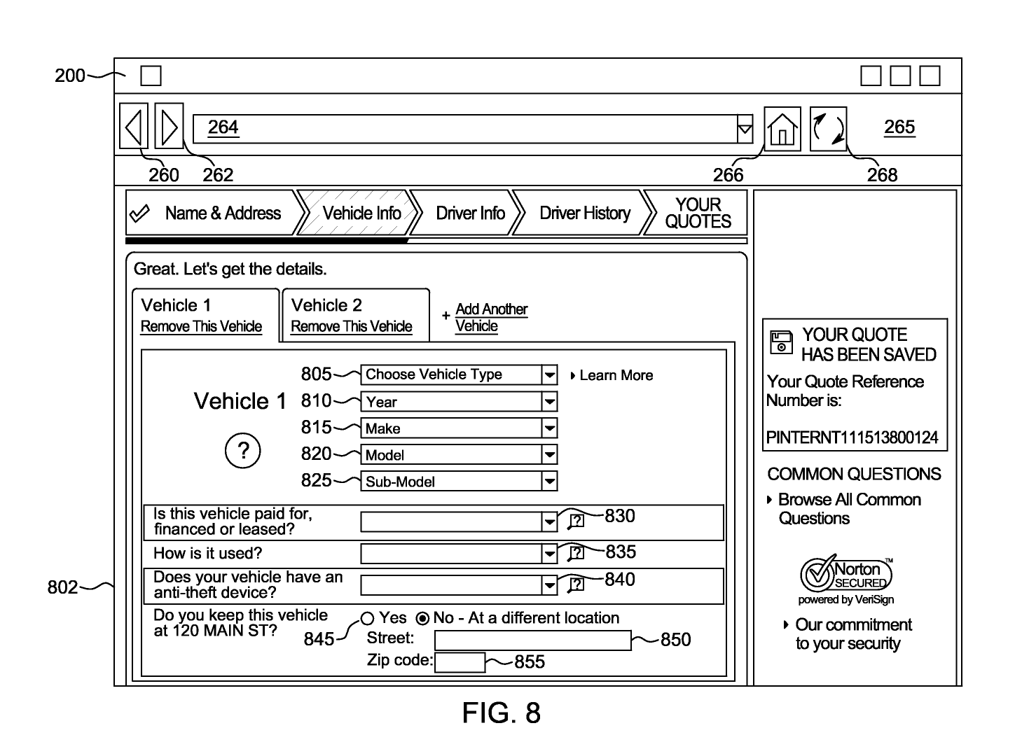

FIG. 8 is an example web page 802 soliciting additional vehicle information regarding a request for a vehicle insurance quote. As shown in FIG. 8, the web page 802 may include radio buttons 805-855, for example, radio buttons Choose Vehicle Type 805, Year 810, Make 815, Model 820, Sub-Model 825, is this vehicle paid for, financed or leased? 830, How Is It used 835, Does your vehicle have an anti-theft device? 840, Yes or No—At a different location 845, Street 850 and Zip code 855. As the user device 130 receives inputs, the web browser module 132 may store one or more data structures (“response data”) that reflect the selections made. Further, as the selections are updated, the web browser module 132 may update the web page 802 to indicate additional or more specific questions that may be associated with the input. The question displayed on web page 802 solicits information regarding the user who is requested to enter vehicle type, year, make, model, and other information. The user is also requested to enter information as to how the vehicle is paid for, how the vehicle is used, whether there is anti-theft equipment, and where the vehicle is stored. The web page 802 also includes tabs to add data for additional vehicles and to remove vehicles. If there are no errors in the transmission, the web browser module 132 is directed to a subsequent web page.

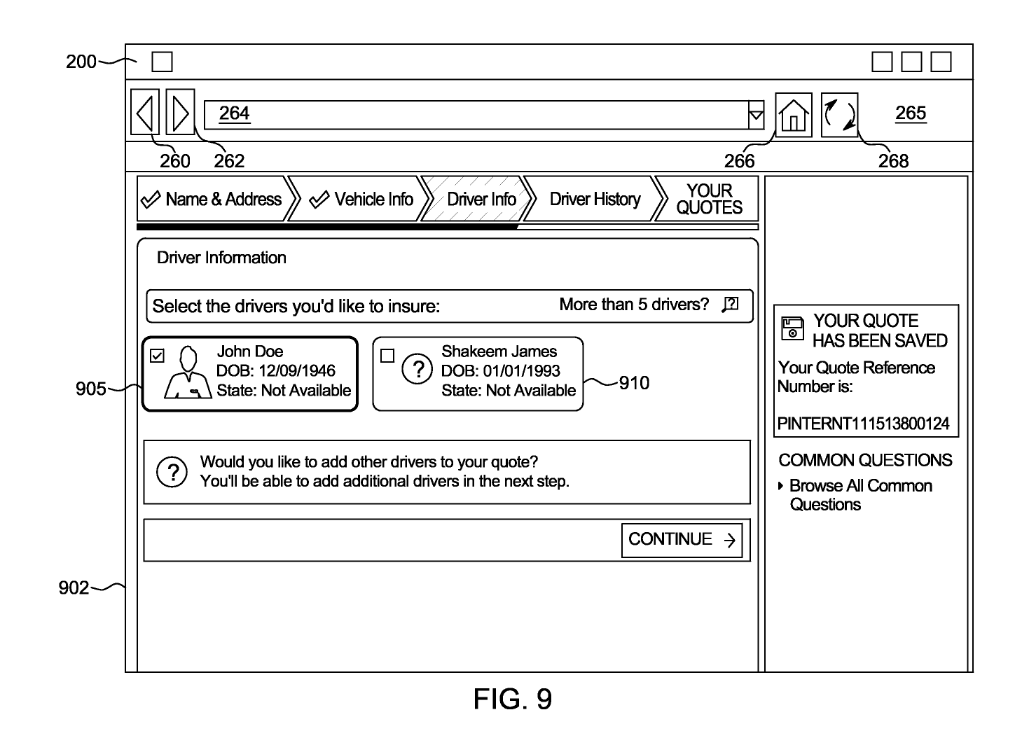

FIG. 9 is an example web page 902 soliciting driver information regarding a request for a vehicle insurance quote. As shown in FIG. 9, the web page 902 may include radio buttons 905 and 910. As the user device 130 receives inputs, the web browser module 132 may store one or more data structures (“response data”) that reflect the selections made. Further, as the selections are updated, the web browser module 132 may update the web page 902 to indicate additional or more specific questions that may be associated with the input. The question displayed on web page 902 solicits information regarding the identity of vehicle(s) for which insurance is being requested. Radio button 905 for example, contains information that is generated based on the user information entered via web page 902. Additionally, the system 100 may be configured to access data associated with the address information and determined suggested drivers, as shown in radio button 910. If there are no errors in the transmission, the web browser module 132 is directed to a subsequent web page.

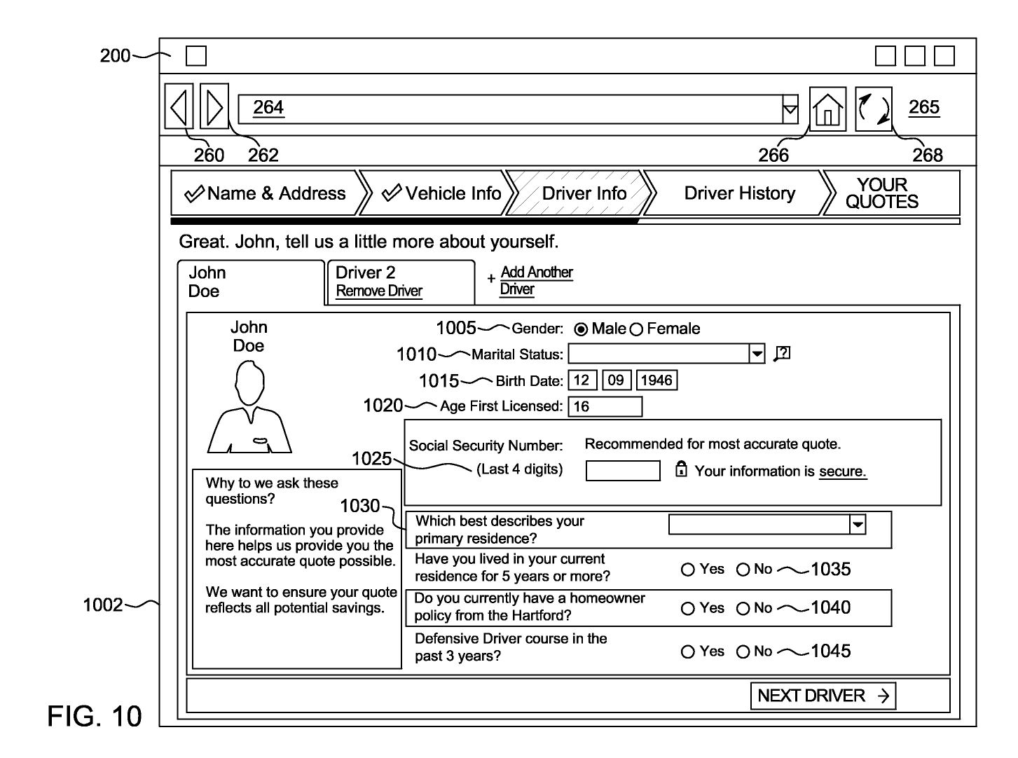

FIG. 10 is an example web page 1002 soliciting additional driver information regarding a request for a vehicle insurance quote. As shown in FIG. 10, the web page 1002 may include input fields 1005 -1045, for example, input fields Gender 1005, Marital Status 1010, Birth Date 1015, Age First Licensed 1020, Social Security Number 1025, Which best describes your primary residence 1030, Have you lived in your current residence for 5 years or more 1035, Do you currently have a homeowner policy from the Hartford? 1040, Defensive Driver course in the past 3 years? 1045. As the user device 130 receives inputs, the web browser module 132 may store one or more data structures (“response data”) that reflect the selections made. Further, as the selections are updated, the web browser module 132 may update the web page 1002 to indicate additional or more specific questions that may be associated with the input. The question displayed on web page 1002 solicits information regarding the identity of vehicle(s) for which insurance is being requested. The system 100 may have access to additional database information to confirm or automatically fill information in the web page 1002. For example, based on the user's social security number, the system 100 may determine background information or confirm the identity. Web page 1002 allows the user to enter all of the additional drivers to be insured, along with their corresponding information. Additional information may also be requested, for example, height, weight, cell phone number, employment information. The system 100 may further be configured to access information, for example from the local department of motor vehicles. This may enable the insurance company to access height and weight information, which may be used for telematics based underwriting as described in greater detail below. If there are no errors in the transmission, the web browser module 132 is directed to a subsequent web page.

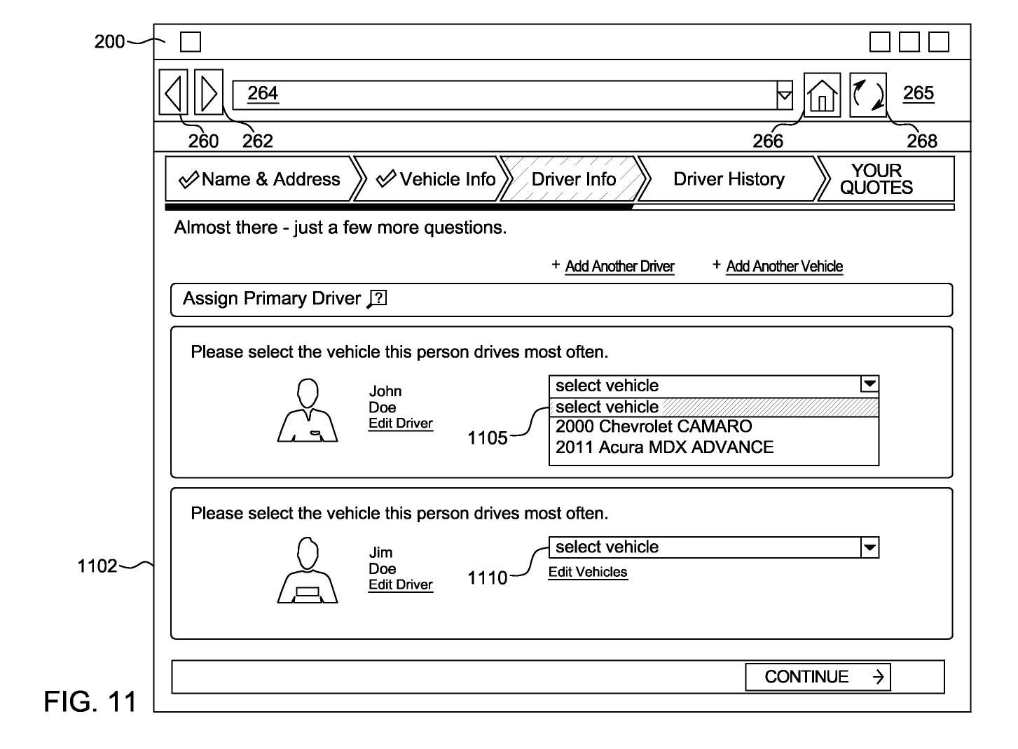

FIG. 11 is another example web page 1102 soliciting additional information regarding a request for a vehicle insurance quote. As shown in FIG. 11, the web page 1102 may include dropdown menus 1105 and 1110. As the user device 130 receives inputs, the web browser module 132 may store one or more data structures (“response data”) that reflect the selections made. Further, as the selections are updated, the web browser module 132 may update the web page 1102 to indicate additional or more specific questions that may be associated with the input. The question displayed on web page 1102 solicits information regarding the primary vehicles being driven by each driver. If there are no errors in the transmission, the web browser module 132 is directed to a subsequent web page.

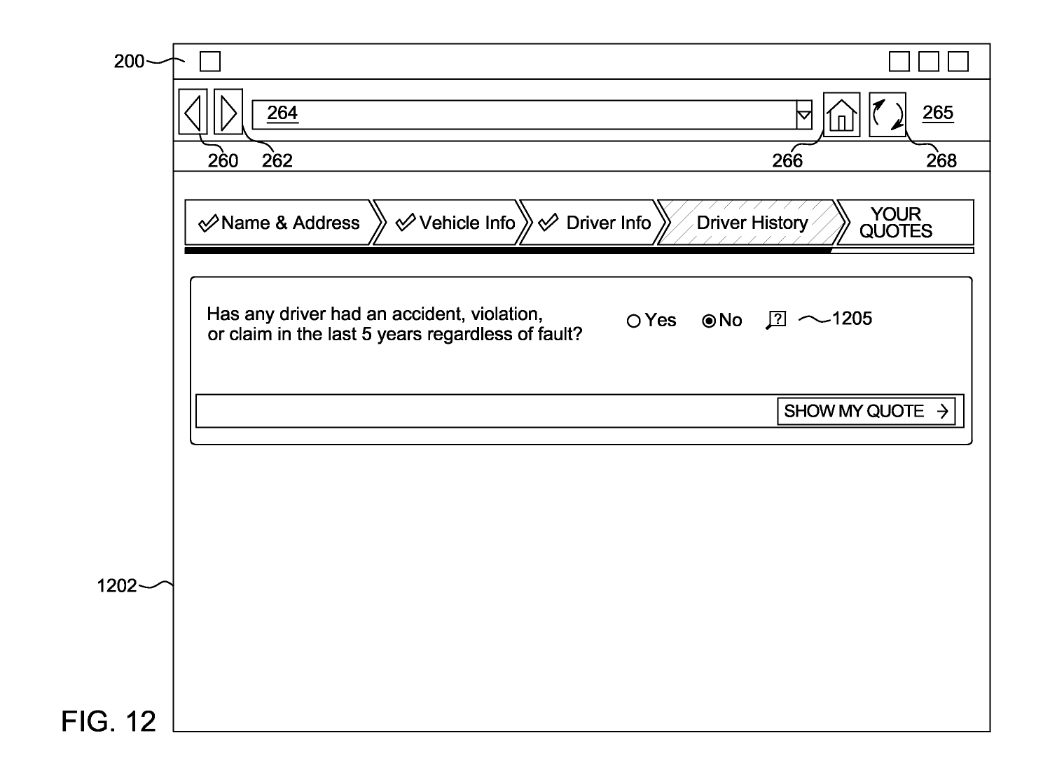

FIG. 12 is an example web page 1202 soliciting driver history information regarding a request for a vehicle insurance quote. As shown in FIG. 12, the web page 1202 may include radio button 1205. As the user device 130 receives inputs, the web browser module 132 may store one or more data structures (“response data”) that reflect the selections made. Further, as the selections are updated, the web browser module 132 may update the web page 1202 to indicate additional or more specific questions that may be associated with the input. The question displayed on web page 1202 solicits information regarding the driver history for each of the drivers. If there are no errors in the transmission, the web browser module 132 is directed to a subsequent web page.

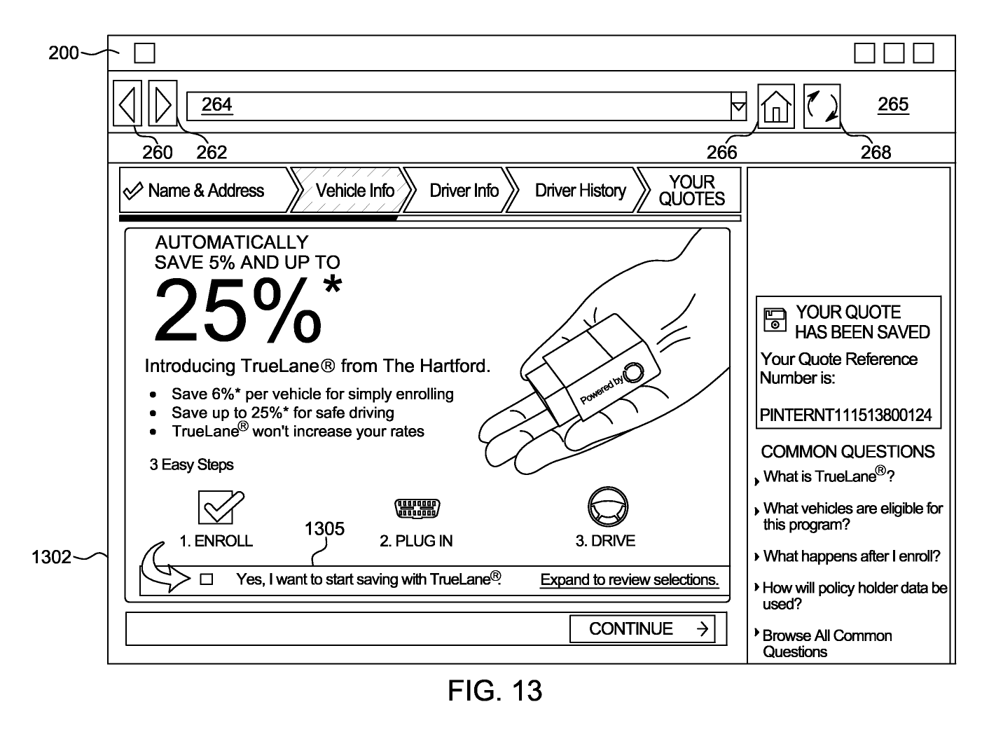

FIG. 13 is an example web page 1302 soliciting a response from the user for registration to TrueLane® telematics program. As shown in FIG. 13, the web page 1302 may include a radio button 1305. As the user device 130 receives inputs, the web browser module 132 may store one or more data structures (“response data”) that reflect the selections made. Further, as the selections are updated, the web browser module 132 may update the web page 1302 to indicate additional or more specific questions that may be associated with the input. Based on the previous answers supplied by the user, the system 100 determines whether the user is eligible for the TrueLane® discount. Alternatively, if the driver or vehicle is in a higher risk category, TrueLane® may be required in order to receive or maintain insurance coverage. The question displayed on web page 1302 confirms enrollment in the TrueLane® telematics program. If there are no errors in the transmission, the web browser module 132 provides a quote.

While the below examples describe a scenario of a new customer registering for insurance and then having the pricing information adjusted based on telematics data, the systems and methods described herein may be applied to current and former customers that are looking to renew their coverage. In this scenario, the biographical information may already be stored on the insurance server 180, and the DPU 170 may access this information directly.

The registration phase is used to generate an initial risk assessment. During the registration phase, the system 100 receives biographical information about each of the drivers that may be associated with the user's account as well as information about the vehicles for which coverage is requested. With millions of accidents each year, a large amount of data is available on factors that may affect the likelihood of an accident as well as the severity of the accident. The database 176 associated with the DPU 170 contains information regarding accident information. The DPU 170, using a multivariate analysis, generates the initial driver assessment based on the provided biographic information verses the factors stored in the database 176.

The DPU 170 may perform a correlative analysis on the entered biographical information to develop the initial risk assessment which may be based in part on the expected speeding, the expected acceleration, the expected turns, the expected braking, the expected mileage driven, the times of day driven, etc. The list above is by no means exhaustive. Based on the entered biographical information, the DPU 170 may also be configured to generate an expectation on time spent in low risk, medium risk, and high risk locations (other than the specific expected locations.) The RPU 160 may use this information to generate pricing information. For example, the RPU 160 may adjust the rate associated with an account, it may credit or debit a rate and/or to determine adjusted pricing information.

The inside of vehicle 140 may comprise a plurality of electronics devices that may communicate information to the telematics device. Most vehicles include at least one microprocessor and memory that connects to each individual electronic device. For example, there may be electronic devices associated with the seats, A/C units, global positioning satellite (GPS)/stereo system, DVD unit, and BLUETOOTH equipment. The microprocessor may also be in communication with the headlights, engine, traffic signals, rear view mirror, rearview cameras, cruise control, braking system and inner workings of the vehicle 140. There may also be additional devices such as multiple mobile phones brought by passengers into a vehicle. The telematics device is configured to receive information from the electronics in the vehicle 140. For example, the telematics device is configured to receive data concerning, speed, acceleration, turns, braking, location, seat settings, lane changes, radio volume, window controls, vehicle servicing, number of cellular devices in a vehicle, proximity to other vehicle's, etc. The telematics device may be configured to transmit this information directly to the DCU 110.

The DCU 110 may format this information and transmit it to the DPU 170. Once the account has been activated, the DPU 170 may be configured to use this information to determine the relativity factors associated with each vehicle.

The telematics device may be configured to record telematics data periodically as well as based on a trigger. Based on this information, the DPU 170 may be configured to determine a plurality of relativity factors for the measured data categories. In one embodiment, the relativity factors may be based on predetermined road segments.

For example, the DPU 170 may also be configured to categorize portions of road as road segments, wherein road segments may be predetermined lengths of road. As a preliminary basis, the DPU 170 may label a first category of roads “highways,” including: interstates, U.S. highways, limited-access highways as “highways” or “primary roads”. The DPU 170 may label a second category of roads as “urban,” including: secondary roads, and local roads of high importance. The DPU 170 may label a third category of roads as “other,” including: local roads of minor importance, alleys, other unpaved roads or footpath.

Alternatively or additionally, the DPU 170 may be configured to determine the relativity factors in relation to nearby drivers or drivers on similar roads under similar conditions.

In a first example, the DPU 170 may be configured to determine a driving location relativity factor. For example, the driving location relativity factor may credit or penalize a driver for driving in locations more or less risky than their home address. The database 176 of the DPU 170 may generate a driving location risk index (DLRI), wherein the DLRI comprises rankings of each driving location, a vehicle may encounter. The DLRI may be based on a predetermined area. This granularity may be adjusted based on the available telematics and loss data. As one example, where allowable by law, the DLRI may be categorized by zip code. After receiving telematics data from the telematics device of vehicle 140, the DPU 170 may be configured to compare the driving location, with the DLRI to determine the relative risk of the locations.

For example, the DPU 170 may calculate the relative risk of the reported locations actually driven compared to the expected home location according to the procedure described below. The DPU 170 may determine the total number of miles driven by zip code. Next, the DPU 170 may calculate a state adjustment factor. The state adjustment factor may be calculated, e.g. according to the equation 1:

State adjustment factor=State Avg. Premium/State Avg. Base Rate. (EQ. 1)

Wherein the state adjustment factor is based on bodily injury, property damage, comprehensive and collision coverage factors. The DPU 170 may use the state adjustment factor may be used to calculate adjusted base rates by zip code, based on Eq. 2 below:

Adjusted Base Rates by Zip Code=State Adjustment Factor×Base Rate (EQ. 2)

The DPU 170 may use this information to generate adjusted base rates for each of the locations. An example of weighted average rates, based on the driving location, is shown in Table 1, below.

TABLE 1
Weighted Average Rates

| ZIP | Miles | Rate |
|---|---|---|
| 10001 | 30% | 100 |
| 10002 | 10% | 130 |
| 10003 | 5% | 150 |
| 10004 (home) | 25% | 125 |
| 10005 | 30% | 240 |

Based on the percentage of miles driven in each zip code, a rate is determined. The driving location relativity is determined according to the Eq. 3.

Driving location relativity=Sqrt(wtd avg of rates/rate of home zip (EQ. 3)

Wherein a DLRI>1 indicates that the vehicle is driven in riskier areas than the home location. And a DLRI<1 indicates that the vehicle is driven in less risky areas than the home location.

The DPU 170 may further be configured to generate a braking relativity factor. To generate a braking relativity factor, the DPU 170 must determine if a predetermined condition is satisfied such that a braking event is declared. For example, the DPU 170 may declare a braking event based on a rate deceleration or the amount of pressure applied to a brake. The database 176 of the DPU 170 may further be configured to store braking benchmarks for each type of road segment. An example of the braking benchmarks is shown below in Table 2.

TABLE 2
Benchmark Braking Threshold

| | Benchmark Braking Threshold (*Based |
|---|---|
| Road Segment | on Median **Based on 75^{th} Percentile) |
| Highway | 0.01 brakes/mile* |
| Urban | 0.07 brakes/mile** |
| Other | 0.03 brakes/mile** |

Based on received telematics data, the DPU 170 determines the frequency and location of each braking event. This information is compiled in the database 176, and the DPU 170, then determines the amount of braking events per mile for each type of road segment and the overall proportion of braking for each road segment. Table 3 shows an example of compiled braking data.

TABLE 3
Compiled Braking Data

| Road | | | |
|---|---|---|---|
| Segment | Braking Events | Miles | Proportion |
| Highway | 0.12 brakes/mile | 2640 | 0.46 |
| Urban | 0.29 brakes/mile | 1650 | 0.29 |
| Other | 0.32 brakes/mile | 1430 | 0.25 |

For each type of road segment, an index is determined, wherein the index=measured/benchmark. For the example above, HW_Index=0.12/0.01, UR_Index=0.29/0.07=4.1, and OT_Index=0.32/0.03.

The DPU 170 may be configured to calculate an overall breaking index by averaging each of the braking indices weighted by the proportion of miles driven on each road. In the example above, the overall braking index may be calculated as follows:

Overall Braking Index=HW_Index*prop_miles_driven_{—}HW+UR_index*prop_miles_driven_{—}UR+OT_Index*prop_miles_driven_Other. (EQ. 4)

The DPU 170 may be configured to rescale the overall braking index and center it around 1. This overall braking index may be scaled according to the following equation:

Scaled Braking Index=(Overall_Braking Index−mean of the distribution)/(standard deviation of the distribution)+1 (EQ. 5)

Wherein the mean and standard deviation of the distribution come from a lookup table

The system 100 may be able to adjust pricing data with or without loss data. For example, in absence of enough credible loss data from telematics devices, (enough losses in the data to have desired statistical power), the system 100 may determine an expected loss value, also known as Expected Pure Premium (EPP) to calculate a braking relativity factor, wherein the EPP is calculated based on conventional class plan variables. The EPP may then be regressed on the telematics variables like braking, speeding etc. in a multivariate scenario to derive coefficients for these telematics variables. In another embodiment, the system 100 may use a univariate analysis and the EPP may be used to calculate the slope for the telematics variable. Using a look up table, stored in database 176, the DPU 170 may map the scaled braking index to a braking relativity factor. An example of mapping a scaled braking index to a braking relativity factor is shown in Table 4 below. According to the Table 4, an expected pure premium may be used.

TABLE 4
Braking Relativity

| | EPP Based Braking Relativity (Square |
|---|---|
| | root of Raw EPP Relativity) **From EPP |
| Scaled_Braking_Index | Relativity Look Up Table |
| .9 | .97 |
| 1 | 1 |
| 2 | 1.3 |

The DPU 170 may further be configured to determine a speeding relativity factor. The database 176 of the DPU 170 may be preconfigured to store a speed benchmark for each road segment. Table 5, below shows an example of a speed benchmark, using the same segments determined for the braking benchmark. This is used as an illustrative example only. In another embodiment, the road segments for speed may be determined based on posted speed limits, or measured clustered driving patterns.

TABLE 5
Benchmark Speeding Threshold

| Road Segment | Benchmark |
|---|---|
| Highway | 75 mph |
| Urban | 25 mph |
| Other | 45 mph |

After receiving the telematics data, the DPU 170 may be configured to calculate the proportion of miles driven 20 mph over the speed benchmark, 10 to 20 mph over the speed benchmark, 1 to 10 mph over the speed benchmark and 0 mph over the speed benchmark for each of the types of road segment. Further, the DPU 170 may be configured to assign weights based on the variance from the speed benchmark. An example for highway segments is shown in Table 6, below. While the table below only shows weights for speed above the speed benchmark, it may also include weights for speeds below the speed benchmark.

TABLE 6
Compiled Speed Data for Highway Segments

| Segment | Miles | Proportion | Risk Weight |
|---|---|---|---|
| HW_20mphover | 39 | 0.01 | 100 |
| HW10to20mphover | 280 | .11 | 85 |
| HW0to10mph_over | 768 | .29 | 65 |
| HW0over | 1552 | .59 | 35 |

The DPU 170 calculates a speeding index for each road segment by multiplying the risk weight of each speed grouping (e.g. HW_{—}20 mphover) by the proportion of miles within that bucket. For example, based on the three equations given below:

HW_Index=Highway_{—}20_mph_over_prop*wt+Highway_{—}10to20_mph_over_prop*wt+Highway_{—}0to10_mph_over_prop*wt+Highway_{—}0_over*wt (EQ. 6)

UR_Index=UR_{—}20_mph_over_prop*wt+UR_{—}10to20_mph_over_prop*wt+UR_{—}0to10_mph_over_prop*wt+UR_{—}0_over*wt (EQ. 7)

OT_Index=OT_{—}20_mph_over_prop*wt+_{—}OT_{—}10to20_mph_over_prop*wt+OT_{—}0to10_mph_over_prop*wt+OT_{—}0_over*wt (EQ. 8)

The DPU 170 may further generate an average of the speeding indices weighted by proportion of miles driven on each road segment to determine an overall speeding index, wherein:

Overall_Speeding_Index=HW_Index*prop_miles_driven_{—}HW+UR_Index*prop_miles_driven_Urban+OT_Index*prop_miles_driven_Other (EQ. 9)

The DPU 170 may further be configured to determine an overall speeding index that is used to determine the speeding relativity factor. Table 7 shows an overall speeding index mapped to a speeding relativity factor.

TABLE 7
Speeding Relativity Factor Mapping

| | EPP Based Speeding Relativity (Square |
|---|---|
| | root of Raw EPP Relativity) *From EPP |
| Overall Speeding Index | Relativity Look Up Table |
| 80 | 56 |
| 100 | 106 |
| 115 | 113 |

The DPU 170 may further be configured to determine a mileage relativity factor. The mileage relativity factor may be based on an expected mileage value entered by the user during the registration phase. The expected mileage is compared with the measured mileage. The DPU 170 may mitigate the effect of the relativity factor, for example by operating on the result with a function. As an example, the mileage relativity may be calculated as follows, using a square root function to mitigate the effect:

Mileage relativity=SQRT(mileage factor based on actual miles driven/mileage factor based on reported miles) (EQ. 10)

The DPU 170 may further be configured to determine a time of day relativity factor. Based on loss data, the DPU 170 may categorize time segments as high risk, low risk and moderate risk. The DPU 170 may measure the relative risk of driving at certain times of day. The DPU 170 may weight each of the times of day, wherein the weighting rewards low risk miles while incrementally penalizing moderate and high risk miles. Based on the received telematics data, the DPU 170 may further calculate the proportion of miles driven within each time of day segment. Table 8, below, shows an example of time of day weighting.

TABLE 8
Showing Risks and Weights used for TOD Relativity

| Time of Day | Proportion of Miles | Risk Weight |
|---|---|---|
| High Risk | .1 | 130 |
| Moderate Risk | .6 | 100 |
| Low Risk | .3 | 75 |

The DPU 170 may then calculate a time of day (TOD) risk index based on the mileage weighted average of TOD risk. The TOD risk index is mapped to a TOD relativity factor, using a lookup table. Table 9 shows a (TOD) risk index and TOD relativity factor based on the example above.

TABLE 9
Time of Day Relativity Factors

| | EPP Based TOD Relativity (Square root |
|---|---|
| | of Raw EPP Relativity) * From EPP |
| TOD_Risk_Index | Relativity Look Up Table |
| 80 | .90 |
| 110 | 1.1 |
| 140 | 1.3 |

The DPU 170 may transmit the relativity factors to the RPU 160. The RPU 160 may be configured to adjust the rate, or provide a discount or surcharge based on the relativity factors according, for example, to the equation below:

Discount relativity=starting discount*driving location relativity*braking relativity*speeding relativity*mileage relativity*time of day relativity (EQ. 11)

The system 100 may further be configured to determine whether the vehicle 140 is a self-driving vehicle, in which an on-board computer operates the vehicle 140. In this case, the effect of the driving time of day or any other factor may be mitigated when determining the pricing information.

The system 100 uses the biographical information provided in web pages 302-1302 as a baseline for generating the initial pricing information. However, using the methods described above and the received telematics data, provided by the telematics device, the system 100 may refine the pricing information by adjusting the rate, providing a credit or surcharge, or rejecting a renewal. In one embodiment, the RPU 160 may access the information stored in the DPU 170 and the determined discount relativity, and use a software based algorithm to determine a discount.

For example, the starting discount may be 10%, and if the product of the direct and indirect exposure ratings with the weighting factors >1, the system 100 may determine the driver is not eligible for a discount.

In one scenario, the system 100 may only receive telematics data for a fixed time period. In this scenario, the RPU 160 may be configured to compensate for the limited duration of the telematics data using a seasonality factor. For example, if the telematics data is received from September-December, and the biographical information indicates one of the insured drivers attends college away from home, RPU 160 may be configured to use the seasonality factor to adjust the pricing information to account for the lack of information transmitted regarding that driver. Conversely, under the same scenario, if the readings were taken during the summer, when the student was home, the telematics data may be skewed the other way. Accordingly, the RPU 160 may use the seasonality factor to account for that.

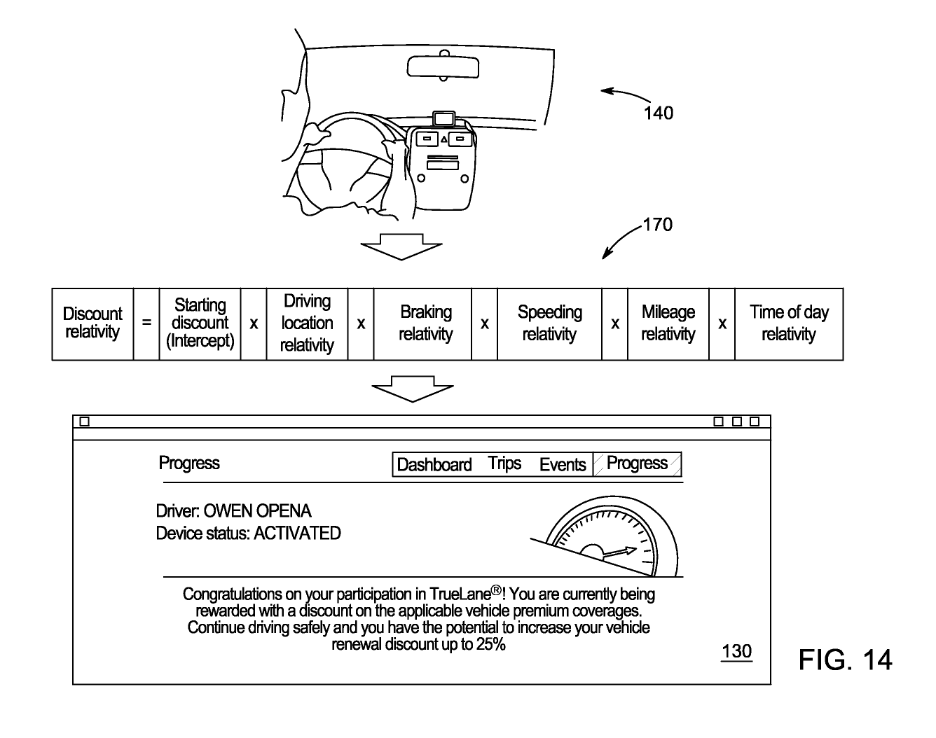

FIG. 14 shows an example visual flow diagram of an embodiment of a system for telematics based underwriting. As shown in FIG. 14, a driver is driving vehicle 140. The vehicle may include multiple electronics devices configured to communicate with a telematics device located in the vehicle. As one example, the driver of the vehicle may load a software application onto his cellular phone and use the phone as a telematics device. The telematics device may receive telematics data including location, acceleration, speeding, and time, etc. The telematics device communicates this information to a third party operated DCU 110. The DCU 110 may be configured to receive raw telematics data and convert it into a different format, e.g. summary telematics data. The DCU 110 may communicate this telematics data in a predetermined format to the DPU 170. FIG. 14 shows an algorithm, implemented in the DPU 170 calculating a plurality of relativity factors. The RPU 160 may use these relativity factors to determine pricing information. The website system 120 may be used to communicate this pricing information to a user device 130, in the form of a web page. As seen in FIG. 14, the user device 130 includes a display that is presenting the user with a discount. In another example, the display may include information that compares the vehicle usage on the policy to other similar vehicles and/or drivers of a similar background. The display may further include suggestion regarding how to improve driving to receive a discount or lower rate.

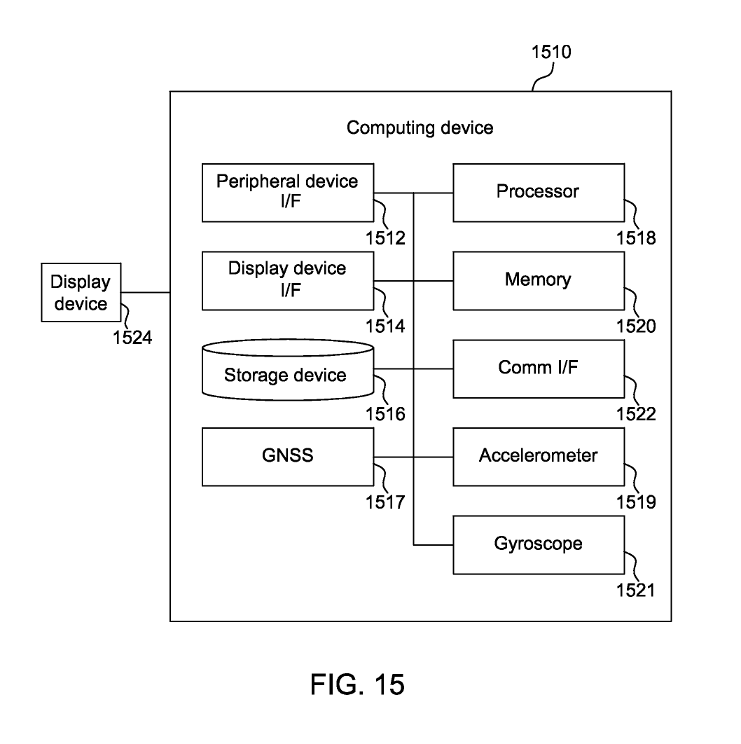

FIG. 15 shows an example computing device 1510 that may be used to implement features described above with reference to FIGS. 1-14. The computing device 1510 includes a global navigation satellite system (GNSS) receiver 1517, an accelerometer 1519, a gyroscope 1521, a processor 1518, memory device 1520, communication interface 1522, peripheral device interface 1512, display device interface 1514, and a storage device 1516. FIG. 15 also shows a display device 1524, which may be coupled to or included within the computing device 1510.

The memory device 1520 may be or include a device such as a Dynamic Random Access Memory (D-RAM), Static RAM (S-RAM), or other RAM or a flash memory. The storage device 1516 may be or include a hard disk, a magneto-optical medium, an optical medium such as a CD-ROM, a digital versatile disk (DVD), or Blu-Ray disc (BD), or other type of device for electronic data storage.

The communication interface 1522 may be, for example, a communications port, a wired transceiver, a wireless transceiver, and/or a network card. The communication interface 1522 may be capable of communicating using technologies such as Ethernet, fiber optics, microwave, xDSL (Digital Subscriber Line), Wireless Local Area Network (WLAN) technology, wireless cellular technology, BLUETOOTH technology and/or any other appropriate technology.

The peripheral device interface 1512 may be an interface configured to communicate with one or more peripheral devices. As an example, the peripheral device may communicate with an onboard diagnostics (OBD) unit that is associated with a vehicle. The peripheral device interface 1512 may operate using a technology such as Universal Serial Bus (USB), PS/2, BLUETOOTH, infrared, serial port, parallel port, and/or other appropriate technology. The peripheral device interface 1512 may, for example, receive input data from an input device such as a keyboard, a mouse, a trackball, a touch screen, a touch pad, a stylus pad, and/or other device. Alternatively or additionally, the peripheral device interface 1512 may communicate output data to a printer that is attached to the computing device 1510 via the peripheral device interface 1512.

The display device interface 1514 may be an interface configured to communicate data to display device 1524. The display device 1524 may be, for example, an in-dash display, a monitor or television display, a plasma display, a liquid crystal display (LCD), and/or a display based on a technology such as front or rear projection, light emitting diodes (LEDs), organic light-emitting diodes (OLEDs), or Digital Light Processing (DLP). The display device interface 1514 may operate using technology such as Video Graphics Array (VGA), Super VGA (S-VGA), Digital Visual Interface (DVI), High-Definition Multimedia Interface (HDMI), or other appropriate technology. The display device interface 1514 may communicate display data from the processor 1518 to the display device 1524 for display by the display device 1524. As shown in FIG. 15, the display device 1524 may be external to the computing device 1510, and coupled to the computing device 1510 via the display device interface 1514. Alternatively, the display device 1524 may be included in the computing device 1510.

An instance of the computing device 1510 of FIG. 15 may be configured to perform any feature or any combination of features described above as performed by the user device 130 and/or telematics device. In such an instance, the memory device 1520 and/or the storage device 1516 may store instructions which, when executed by the processor 1518, cause the processor 1518 to perform any feature or any combination of features described above as performed by the web browser module 132. Alternatively or additionally, in such an instance, each or any of the features described above as performed by the web browser module 132 may be performed by the processor 1518 in conjunction with the memory device 1520, communication interface 1522, peripheral device interface 1512, display device interface 1514, and/or storage device 1516.

Although FIG. 15 shows that the computing device 1510 includes a single processor 1518, single memory device 1520, single communication interface 1522, single peripheral device interface 1512, single display device interface 1514, and single storage device 1516, the computing device 1510 may include multiples of each or any combination of these components, and may be configured to perform, mutatis mutandis, analogous functionality to that described above.

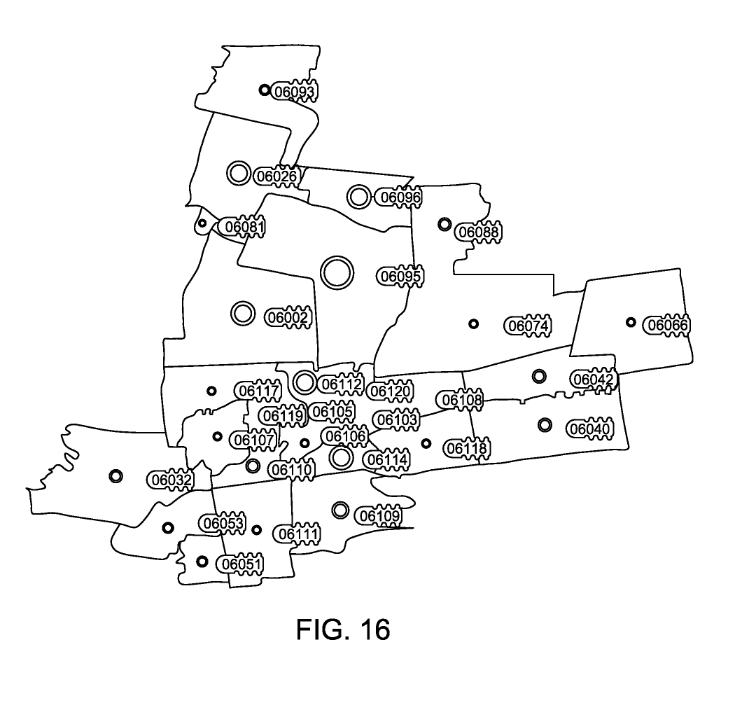

FIG. 16 shows an example graph for a DLRI for a zip code based calculation. As shown in FIG. 16, a map is comprised with different shades of gray indicate the categorization for an area based on zip code. In the example shown, light gray indicates a low risk area, dark gray indicates a medium risk area, and black indicates high risk area. The DLRI may be determined by the DPU 170 based on loss data received by the DPU 170. This loss data may be directly measured by the DPU 170, or it may be received from an external server 180. The DPU 170 may determine multiple DLRI maps for each type of coverage. The DPU 170 receives telematics data regarding the location of the vehicle 140. The DPU 170 determines the amount of time spent in each risk category. A driving location relativity factor is determined based on this information. The RPU 160 may use this driving location relativity factor in determining an adjustment to the pricing information. While the example shown in FIG. 16 shows only three categories that are assigned for each zip code, the system 100 may use more or less categories and use different standard units of area. Additionally, while the example shown in FIG. 16 shows the unit area of the DLRI calculation as the area represented by a zip code, the actual unit of area may be different.

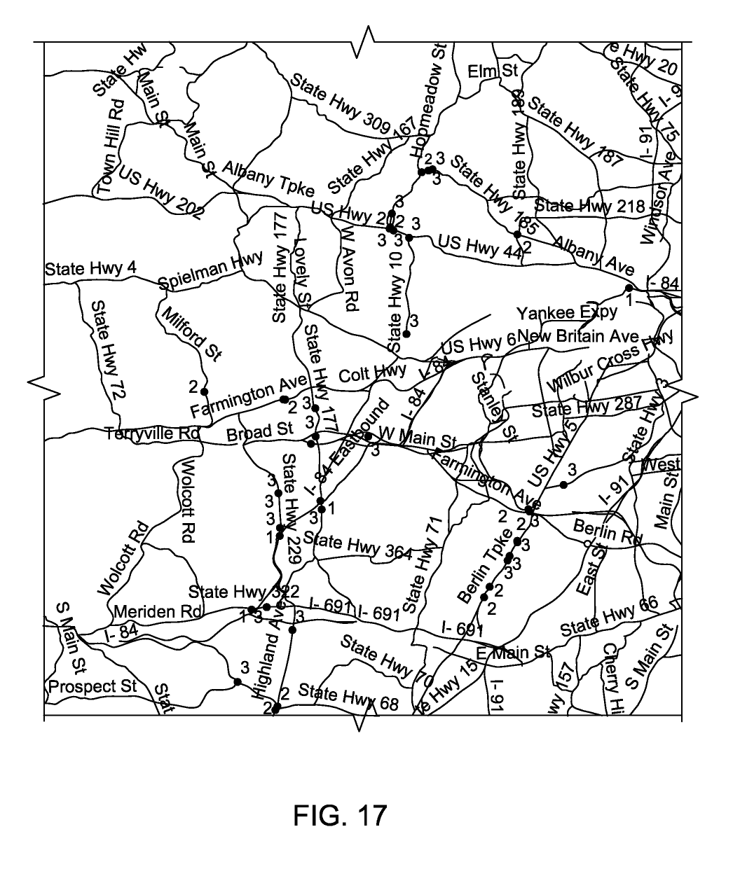

As described above, the relativity factors may be based on different units of area. In another example, the relativity factors may be determined relative to road segments travelled (e.g. braking per road segment). FIG. 17 shows an example graph for defining road segments that may be used for road segment based calculations. FIG. 17 shows a map with all of the listed roads in an area. As shown in FIG. 17, there may be highways, state roads, local roads, etc. The DPU 170 may be configured to categorize portions of each of these roads as a “segment.” Alternatively, this information may be predetermined and sent to the DPU 170. The DPU 170 may assign values to each segment, wherein the value indicates whether a road segment is highway, urban or other. In the example given in FIG. 17, 1 represents other, 2 represents urban and 3 represents highway. The portions identified on FIG. 17 are shown as an example, however, road segment identification may be identified with more granularity and based on other factors. For example, the road segments may be categorized based on posted speed limits etc. For each category of road segment, the DPU 170 may include predetermined expected driving behaviors, such as acceleration, speed, braking, lane changes, etc. The DPU 170 receives telematics data concerning the location of the vehicle 140. The DPU 170 may use these designations to compare raw numbers, such as speed, braking etc. The segment lengths may be determined based on preselected highway segments.

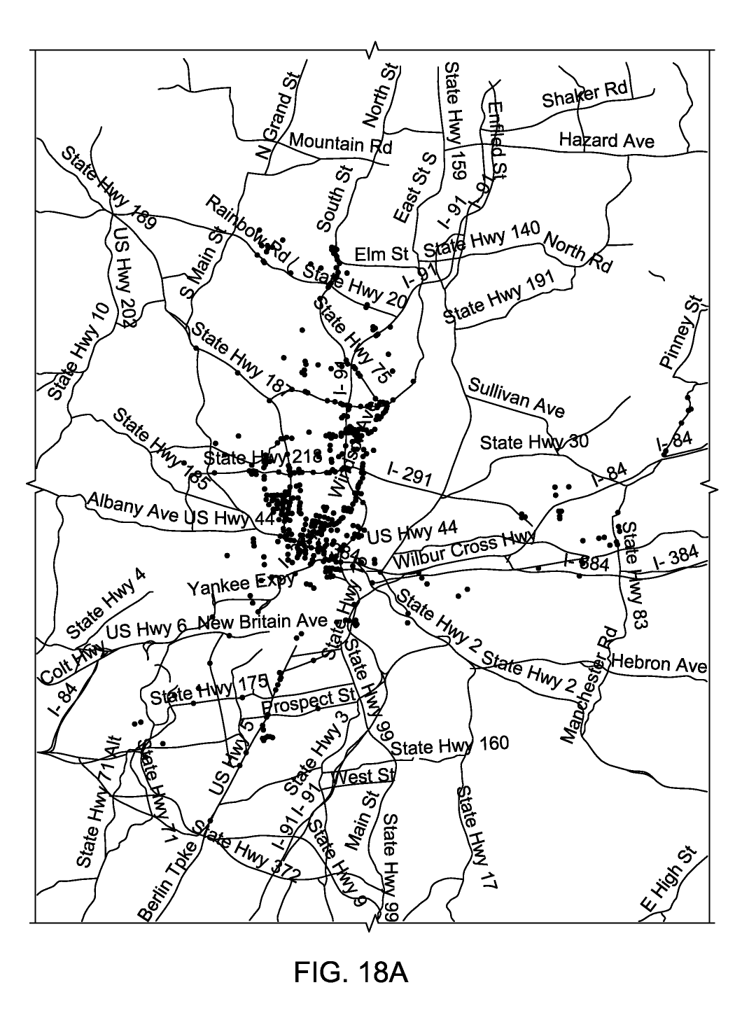

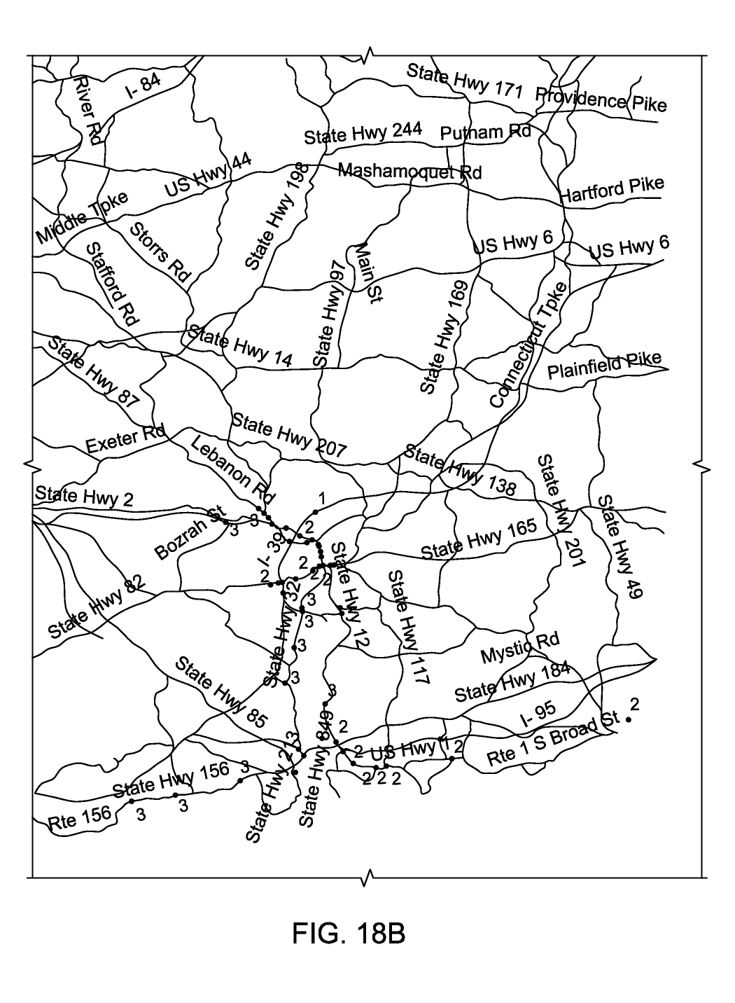

FIGS. 18A and 18B show example maps showing high braking relativity per road segment and low braking relativity per road segment, respectively. In general, the expectation for a driver is to break more in urban settings and less in highway settings. As noted above, the system 100 may be configured to use the telematics data to identify braking events. This may be determined by receiving information when the braking system is activated (e.g. by stepping on the brake) or by measuring the acceleration/deceleration of a vehicle, or the system may detect a change in speed greater than a predetermined threshold. Once a braking event is identified, the system 100 may also store the location of the braking event. This system 100 may correlate this information with the stored road segment information to determine the category of the road segment on which the braking event occurred. The DPU 170 may compare the number of observed braking events per each category of road segment with the expected braking events for this category of road segment. This may be measured in braking events/mile. The DPU 170 may then use this information to determine a breaking relativity factor. The DPU 170 may further be configured to determine breaking relativity relative to nearby drivers, or established rules of the road.

As shown in FIG. 18A, each of the square dots in the figure represents a detected braking event. The vehicle 140 is shown to have a concentration/frequency of braking events in a small area. The relativity factor is calculated relative to the expected braking for each category of road segment. A higher number of braking events is to be expected in an urban setting, which may have higher traffic and a higher number of obstacles. Accordingly, the relativity factor accounts for the category of road segment on which the braking has occurred. In the example shown, a high number of braking events have occurred on highways, which is likely to yield a higher braking relativity.

Regarding FIG. 18B, each of the numbered points in the figure represents a detected braking event. FIG. 18B shows a lower concentration/frequency of braking events. As discussed in reference to FIG. 18B, the concentration/frequency of braking events per road segment may be dependent on the category of the road segment. The DPU 170 calculates the breaking relativity, relative to the category of each of these road segments; accordingly, the total number of braking events in each category is weighted verses the expected number of braking events per mile in each category. The DPU 170 then determines a braking relativity factor that may be used to adjust the pricing information.

The system 100 may further include a user transmission device (not pictured) wherein the user transmission device may communicate insurance information, including pricing information, contractual information, information related to the telematics program, and other notifications. A user transmission device may include one or more modes of communication to reach a potential customer, current customer, or past customer or other similar user. For example, the user transmission device may be coupled with a printing device that is automatically mailed to the user. In another embodiment, the user transmission device may be coupled to a device to generate automatic telephone calls, or “robo-calls,” or other similar communication mediums to communicate with the user. The user transmission device may further be configured to send e-mails to a user. The user device may further be configured to communicate via social media.

The system 100 may communicate this information during a renewal period. Additionally, the system 100 may be configured to proactively communicate this information and/or adjust the pricing information based on exposure changes determined by the system 100 that may occur within or outside of the renewal period.

The multivariate predictive model(s) may include one or more of neural networks, Bayesian networks (such as Hidden Markov models), expert systems, decision trees, collections of decision trees, support vector machines, or other systems known in the art for addressing problems with large numbers of variables. In embodiments, the predictive models are trained on prior data and outcomes using a historical database of insurance related data and resulting correlations relating to a same user, different users, or a combination of a same and different users. In embodiments of the present invention, the predictive model may be implemented as part of the DPU 170 or RPU 160 described with respect to FIG. 1.

As used herein, the term “processor” broadly refers to and is not limited to a single- or multi-core processor, a special purpose processor, a conventional processor, a Graphics Processing Unit (GPU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

As used to herein, the term “computer-readable medium” broadly refers to and is not limited to a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVD, or BLU-RAY disc, or other type of device for electronic data storage.

Although the methods and features described above with reference to FIGS. 2-18 are described above as performed using the example architecture of system 100 of FIG. 1, the methods and features described above may be performed, mutatis mutandis, using any appropriate architecture and/or computing environment. Although features and elements are described above in particular combinations, each feature or element can be used alone or in any combination with or without the other features and elements. For example, each feature or element as described above with reference to FIGS. 1-18 may be used alone without the other features and elements or in various combinations with or without other features and elements. Sub-elements of the methods and features described above with reference to FIGS. 1-18 may be performed in any arbitrary order (including concurrently), in any combination or sub-combination.

1. A system for determining pricing information associated with a vehicle, the system comprising:
a computer memory for storing biographical information associated with one or more drivers related to the vehicle, the biographical information including an expected total mileage driven by the vehicle, the computer memory further configured to store an initial risk assessment based on at least on the expected total mileage driven;
a receiver configured to receive information associated with a vehicle's related telematics data indicating at least vehicle location and a time stamp;
a processor configured to determine, based at least in part on the vehicle's related telematics data, a plurality of relativity factors, wherein relativity factors are numerical values generated based on a comparison of the information associated with the received telematics data for the vehicle with other vehicles' corresponding telematics related data;
the processor further configured to calculate a product of the plurality of relativity factors and compare the product with a predetermined threshold;
the processor further configured to adjust insurance pricing information based on the calculated comparison; and
a transmitter configured to transmit the adjusted insurance pricing information to a user device or user transmission device.

2. The system of claim 1, wherein the telematics data is received directly from a telematics device.

3. The system of claim 1, wherein the telematics data is received from a third party vendor.

4. The system of claim 3, wherein the telematics data is provided by the third party vendor in a summary form.

5. The system of claim 1, wherein one of the plurality of relativity factors is a driving location relativity factor that is a numerical value comparing based at least in part on a zip code in which a vehicle is driving.

6. The system of claim 1, wherein one of the plurality of relativity factors is a braking relativity factor that is a numerical value based at least in part on a measured number of braking events over a road segment.

7. The system of claim 1, wherein one of the plurality of relativity factors is a speeding relativity factor that is a numerical value based at least in part on a measured speed of the vehicle.

8. The system of claim 1, wherein one of the plurality of relativity factors is a mileage relativity factor that is a numerical value based at least in part on a measured mileage driven over a predetermined time range.

9. The system of claim 1, wherein one of the plurality of relativity factors is a time of day relativity factor that is a numerical value based at least in part on a measured time of day during which the vehicle is driven.

10. The system of claim 7, wherein the speeding relativity factor is relative to a posted speed limit.

11. The system of claim 7, wherein the speeding relativity factor is relative to other nearby drivers.

12. A computer based method for determining insurance pricing information associated with a vehicle, the method comprising:
storing, by a computer memory, biographical information associated with one or more drivers related to the vehicle, the biographical information including an expected total mileage driven by the vehicle, the computer memory further configured to store an initial risk assessment based at least on the expected total mileage driven;
receiving, by a receiver, information associated with a vehicle's related telematics data indicating at least vehicle location and speed and a time stamp;
determining, by a processor, a plurality of relativity factors, based at least in part on the telematics data, wherein relativity factors are numerical values generated based on a comparison of the information associated with the received telematics data for the vehicle with other vehicle's corresponding telematics related data;
calculating, by the processor, a product of the plurality of relativity factors with and compare the product with a predetermined threshold; and
adjusting, by the processor, an insurance pricing information based on the calculated comparison; and
transmitting, by a transmitter, the adjusted insurance pricing information to a user device or user transmission device.

13. The method of claim 12, wherein the information associated with received telematics data comprises a summary of telematics data received by a third party system.

14. The method of claim 12, further comprising transmitting, by a transmitter, the adjusted insurance pricing information to a user device.

15. The method of claim 12 further comprising, displaying, by a display associated with the user device, the adjusted insurance pricing information.

16. The method of claim 13, further comprising: transmitting, by a transmitter, the adjusted insurance pricing information to a user device.

17. The method of claim 14, further comprising: displaying, by a display associated with the user device, the adjusted insurance pricing information.

18. The method of claim 12 wherein the information associated with received telematics data is limited to a predetermined time period.

19. The method of claim 18, further comprising: adjusting, by the processor, at least one of the plurality of relativity factors based on a seasonality factor associated with the predetermined time period.

20. The method of claim 12, wherein the insurance pricing information is adjusted during a renewal period.

21. A system for determining pricing information associated with a vehicle, the system comprising:
a computer memory for storing biographical information associated with one or more drivers related to the vehicle;
a receiver configured to receive information associated with a vehicle's related telematics data indicating at least two insurance risk factors;
a processor configured to determine, based at least in part on the telematics data, a plurality of relativity factors, wherein relativity factors are generated based on a comparison of the risk factor information associated with the received telematics data for the vehicle with a plurality of other vehicles' corresponding telematics related data;
the processor further configured to adjust insurance pricing information based at least in part on the calculated comparison; and
a transmitter configured to transmit the adjusted insurance pricing information to a user device or user transmission device.

22. The system of claim 21, wherein one of the plurality of relativity factors is a lane change relativity factor.

23. The system of claim 21, wherein one of the plurality of relativity factors is a speeding relativity factor, wherein the speeding is relative to posted speed limits.

24. The system of claim 22, wherein one of the plurality of factors is based at least in part on a driving location risk index (DLRI).
